(19) United States
(12) Patent Application Publication
(10) Pub. No.: US 2023/0057162 A1
(43) Pub. Date: Feb. 23, 2023

(54) METHODS FOR MANUFACTURING GEOPOLYMER CONCRETE USING RECYCLED WIND TURBINE ROTOR BLADES

(71) Applicant: General Electric Company, Schenectady, NY (US)

(72) Inventors: Xiaopeng Li, Niskayuna, NY (US); Arvind Rangarajan, San Ramon, CA (US); Robenson Cherizol, Metairie, LA (US); Yangang Liang, Richland, WA (US)

(21) Appl. No.: 17/792,509

(22) PCT Filed: Jan. 14, 2020
(86) PCT No.: PCT/US2020/013445

§ 371 Date: Jul. 13, 2022

(51) Int. Cl. C04B 28/00; C04B 18/04

(52) U.S. Cl. CPC C04B 28/006; C04B 18/0427

(57) ABSTRACT

A method for recycling a used rotor blade of a wind turbine includes processing the used rotor blade into a plurality of material fragments. The method also includes treating the plurality of material fragments to remove at least a portion of the at least one composite material and expose the at least one fiber material of the used rotor blade. Further, the method includes mixing the treated plurality of material fragments with, at least, an alkali activator to form a usable geopolymer concrete.

### RELATED APPLICATIONS

The present application claims priority to PCT Application Serial Number PCT/US2020/013445, filed on Jan. 14, 2020, which is incorporated by reference herein.

### FIELD

The present disclosure relates generally to wind turbines and, more particularly, to methods for manufacturing geopolymer concrete using recycled wind turbine rotor blades and associated manufacturing materials.

### BACKGROUND

Wind power is considered to be one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

Wind turbine rotor blades are generally constructed of a fiber-reinforced composite material. Further, wind turbine rotor blades are generally designed for a 20-year life span. Due to the size of such rotor blades, researchers estimate that the U.S. alone will have more than 720,000 tons of blade material to dispose of over the next 20 years. The current practice for disposing of this blade material includes landfill disposal.

Accordingly, there is a need for improved methods of recycling such rotor blades to avoid the need for excessive landfill space. Thus, the present disclosure is directed to methods for manufacturing geopolymer concrete using recycled wind turbine rotor blades that can then be reused in various applications.

### BRIEF DESCRIPTION

Aspects and advantages of the invention will be set forth in part in the following description, or may be obvious from the description, or may be learned through practice of the invention.

In one aspect, the present disclosure is directed to a method for recycling a used rotor blade of a wind turbine. The used rotor blade is formed of at least one composite material reinforced with at least one fiber material. As such, the method includes processing the used rotor blade into a plurality of material fragments. The method also includes treating the plurality of material fragments to remove at least a portion of the at least one composite material and expose the at least one fiber material of the used rotor blade. Further, the method includes mixing the treated plurality of material fragments with, at least, an alkali activator to form a usable geopolymer concrete.

In another embodiment, processing the rotor blade into the plurality of material fragments may include, for example, at least one of manually cutting the rotor blade into the plurality of material fragments or machining the rotor blade into the plurality of material fragments. In another embodiment, a maximum dimension of each of the plurality of material fragments may be equal to or below 80 millimeters (mm).

In an embodiment, treating the plurality of material fragments to remove at least a portion of the at least one composite material and expose the fiber material(s) of the used rotor blade may include, for example, immersing at least a portion of each of the plurality of material fragments into a solvent material and subsequently removing the plurality of material fragments from the solvent material, applying temperature variations to each of the plurality of material fragments, applying mechanical processes to each of the plurality of material fragments, and/or combinations thereof.

In further embodiments, the solvent material may include, for example, sulfuric acid, nitric acid, acetone, isopropanol, xylene, hydrogen peroxide, or any other suitable solvent.

In additional embodiments, the method may include mixing the treated plurality of material fragments with the alkali activator and one or more additional materials to form the usable geopolymer concrete. In such embodiments, the additional material(s) may include, for example, water, a superplasticizer, one or more pozzolanic materials, one or more coarse or fine aggregates, or combinations thereof. More specifically, in an embodiment, the pozzolanic ingredient(s) may include, for example, fly ash, blast furnace slag, metakaolin, or silica fume. Further, in an embodiment, the one or more coarse or fine aggregates may include, for example, sand, gravel, stone, or recycled concrete aggregates.

In several embodiments, the fiber material(s) may include glass fibers, carbon fibers, polymer fibers, wood fibers, bamboo fibers, ceramic fibers, metal fibers, basalt fibers, or similar or combinations thereof. For example, in an embodiment, the fiber material(s) may include glass fibers. In such embodiments, the glass fibers are configured to react with the alkali activator to form the usable geopolymer concrete.

In particular embodiments, the method may also include using the usable geopolymer concrete to form a tower structure, e.g. such as a tower of another wind turbine.

In another aspect, the present disclosure is directed to a geopolymer concrete. The geopolymer concrete includes a slurry formed of a plurality of material fragments formed from a used rotor blade of a wind turbine or rotor blade manufacturing materials, an alkali activator, and water with one or more additional materials dissolved therein. Further, each of the plurality of material fragments has a portion of resin removed therefrom to expose at least one fiber material of the used rotor blade. As such, the exposed fiber material(s) is configured to react with the alkali activator. It should be understood that the geopolymer concrete may further include any of the additional features described herein.

In yet another aspect, the present disclosure is directed to a method for recycling a fiber-reinforced composite component. The fiber-reinforced composite component is formed of at least one composite material reinforced with at least one fiber material. The method includes processing the fiber-reinforced composite component into a plurality of material fragments, treating the plurality of material fragments to remove at least a portion of a coating of the fiber-reinforced composite component and expose the at least one fiber material of the fiber-reinforced composite component, and mixing the removed plurality of material fragments with, at least, an alkali activator to form a usable geopolymer concrete. It should be understood that the wind turbine may further include any of the additional features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates a schematic diagram of a portion of the rotor blade of FIG. 2, particularly illustrating the rotor blade being formed of a composite material reinforced with a fiber material;

FIG. 4 illustrates a flow diagram of one embodiment of a method for recycling a used rotor blade of a wind turbine according to the present disclosure; and

FIG. 5 illustrates a flow diagram of one embodiment of a method for recycling a used rotor blade of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to methods for manufacturing geopolymer concrete using recycled end-of-life and process waste wind turbine rotor blade materials that can be used for tower construction or other concrete constructions, using for example 3-D concrete printing, slip-forming, cast-in-place, etc. More specifically, before adding the recycled blade materials into the geopolymer concrete mix, the recycled blade materials may be processed, e.g. with solvents, thermal, or mechanical processes, to dissolve the surface resin. As such, fibers within the blade materials can be exposed, thereby allowing geopolymerization between the fibers and alkali used to form the geopolymer concrete. Thus, methods of the present disclosure avoid the cost of landfilling the wind turbine blade materials and also reduces the cost of tower construction by using recycled materials.

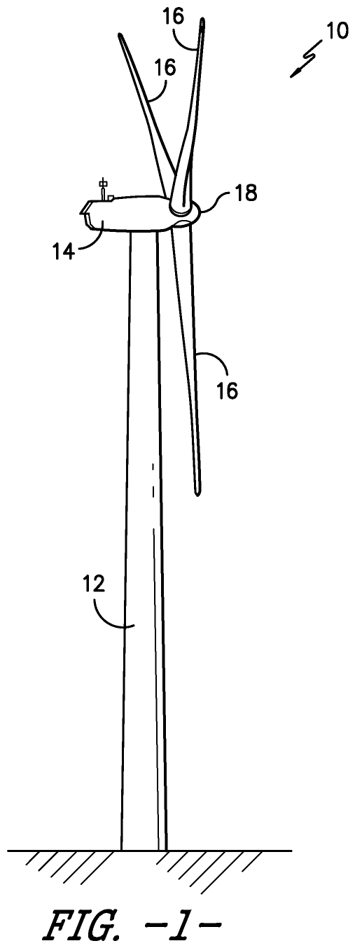

Referring to the drawings, FIG. 1 illustrates perspective view of a wind turbine 10 according to the present disclosure. As shown, the wind turbine 10 includes a tower 12 with a nacelle 14 mounted thereon. A plurality of rotor blades 16 are mounted to a rotor hub 18, which is, in turn, connected to a main flange that turns a main rotor shaft (not shown). The wind turbine power generation and control components are generally housed within the nacelle 14. It should be appreciated that the wind turbine 10 of FIG. 1 is provided for illustrative purposes only to place the present invention in an exemplary field of use. Thus, one of ordinary skill in the art should understand that the invention is not limited to any particular type of wind turbine configuration.

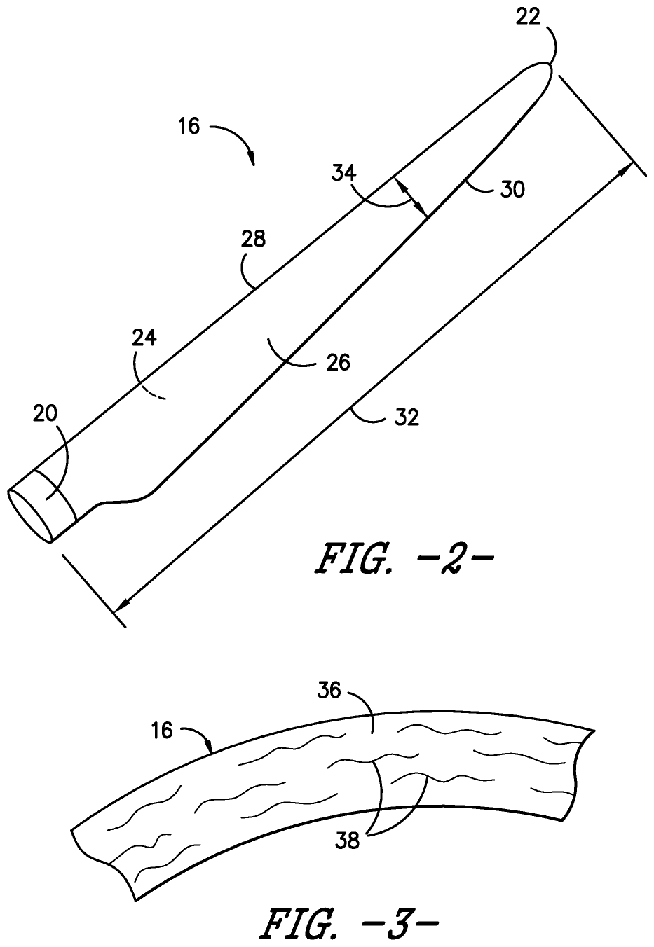

Referring now to FIG. 2, there is illustrated a perspective view of a rotor blade 16 according to the present disclosure. As shown, the rotor blade 16 generally includes a blade root 20 configured for mounting the rotor blade 16 to a mounting flange (not shown) of the wind turbine hub 18 (FIG. 1) and a blade tip 22 disposed opposite the blade root 20. The rotor blade 16 may also include a pressure side 24 and a suction side 26 extending between a leading edge 28 and a trailing edge 30. Additionally, the rotor blade 16 may include a span 32 defining the total length between the blade root 20 and the blade tip 22 and a chord 34 defining the total length between the leading edge 28 and the trailing edge 30. As is generally understood, the chord 34 may vary in length with respect to the span 32 as the rotor blade 16 extends from the blade root 20 to the blade tip 22.

Additionally, the rotor blade 16 may define any suitable aerodynamic profile. Thus, in several embodiments, the rotor blade 16 may define an airfoil shaped cross-section. For example, the rotor blade 16 may be configured as a symmetrical airfoil or a cambered airfoil. Further, the rotor blade 16 may also be aeroelastically tailored. Aeroelastic tailoring of the rotor blade 16 may entail bending the blade 16 in a generally chordwise direction and/or in a generally spanwise direction. The chordwise direction generally corresponds to a direction parallel to the chord 34 defined between the leading and trailing edges 28, 30 of the rotor blade 16. Additionally, the spanwise direction generally corresponds to a direction parallel to the span 32 of the rotor blade 16.

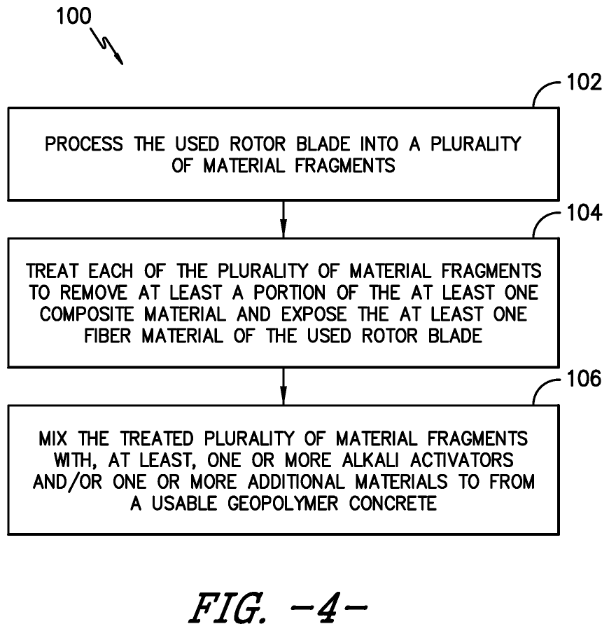

Referring now to FIG. 3, the rotor blades 16 described herein are generally formed of at least one composite material 36 reinforced with at least one fiber material 38. For example, the composite material 36 may include a thermoplastic material or a thermoset material. Thermoplastic materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material. For example, in one embodiment, a semi-crystalline thermoplastic resin that is modified to have a slow rate of crystallization may be used. In addition, blends of amorphous and semi-crystalline polymers may also be used.

Further, the thermoset materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

In addition, as mentioned, the thermoplastic and/or the thermoset material as described herein may optionally be reinforced with a fiber material 38, including but not limited to glass fibers, carbon fibers, polymer fibers, wood fibers, bamboo fibers, ceramic fibers, nanofibers, metal fibers, or similar or combinations thereof. In addition, the direction of the fibers may include multi-axial, unidirectional, biaxial, triaxial, or any other another suitable direction and/or combinations thereof.

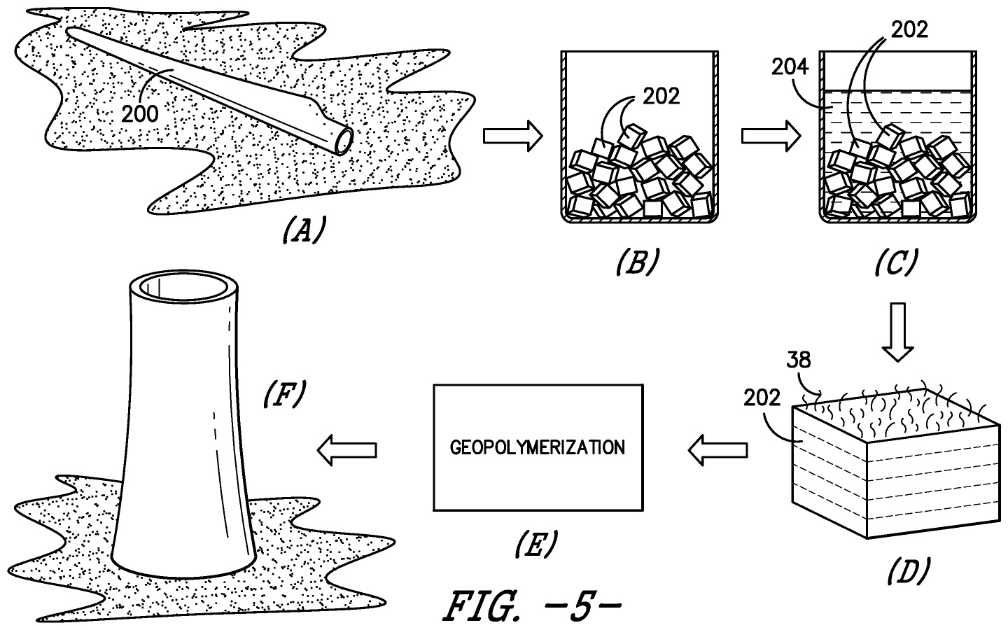

Referring now to FIG. 4, a flow diagram of one embodiment of method 100 for recycling a used rotor blade of a wind turbine is illustrated. In general, the method 100 is described herein with reference to the wind turbine 10 and the rotor blades 16 of FIGS. 1-3. However, it should be appreciated that the disclosed method 100 may be implemented with rotor blades having any other suitable configurations. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (102), the method 100 includes processing a used rotor blade into a plurality of material fragments. For example, as shown in FIG. 5 at steps (A) and (B), the used rotor blade may correspond to a decommissioned rotor blade 200, such as one of the rotor blades 16 illustrated in FIG. 1, that is broken down into a plurality of material fragments 202. For example, in an embodiment, the rotor blade 200 may be processed into the material fragments 202 by manually cutting the rotor blade 200 or machining the rotor blade 200 into the material fragments 202 using, for example, any suitable tool. Furthermore, a maximum dimension of each of the plurality of material fragments 202 (such as the length, width, height, diameter, etc.) may be equal to or below 80 millimeters (mm). Although, in further embodiments, the material fragments 202 may be understood to have any suitable size and/or shape. It should be further understood that the used rotor blade may include any decommissioned rotor blade such as a rotor blade that has reached the end of its operating life, a damaged rotor blade, or any other rotor blade that is otherwise more valuable being used as a recyclable material rather than as an operable rotor blade.

Referring back to FIG. 4, as shown at (104), the method 100 includes treating the plurality of material fragments 202 to remove at least a portion of the composite material(s) and expose the fiber material(s) of the used rotor blade. For example, in one embodiment, the method 100 may include immersing at least a portion of each of the plurality of material fragments 202 into a solvent material to dissolve a surface coating and expose the fiber material(s) 38 of the used rotor blade 200. For example, in an embodiment, the solvent material may include, for example, sulfuric acid, nitric acid, acetone, isopropanol, xylene, hydrogen peroxide, or any other suitable solvent. Further, as shown in FIG. 5 at step (C), the material fragments 202 may be submerged into a solvent bath 204 for processing. It should also be understood that any additional mechanical methods, such as mixing, vibrating, etc., as well as thermal processes, can be combined or used independently of the solvent dissolving method. For example, in an embodiment, any high temperature process, such as pyrolysis, can also be adopted and/or combined with the solvent dissolving method.

Referring back to FIG. 4, as shown at (106), the method 100 includes removing the plurality of material fragments 202 from the solvent material 204. Such removal allows the material fragments 202 to be wiped at least partially dry such that some residual solvent material remains on the fragments or the fragments may be rinsed with water to remove all solvent material and then wiped dry for further processing. For example, as shown in FIG. 5, at step (D), one of the material fragments 202 is illustrated after removal from the solvent material 204. As shown, the surface coating has been removed and some of the fiber materials thereof are exposed.

Accordingly, as shown in FIG. 4 at (108) and step (E) of FIG. 5, the method 100 includes mixing the removed plurality of material fragments 202 with, at least, one or more alkali activators and/or one or more additional materials(s) to form a usable geopolymer concrete (e.g. through the process of geopolymerization). For example, in such embodiments, the alkali activator(s) may include, for example, potassium salts, sodium hydroxide, lime, sodium carbonate, or sodium silicate. In addition, in such embodiments, the additional material(s) may include, for example, water, a superplasticizer, one or more pozzolanic materials, one or more coarse or fine aggregates, or combinations thereof. More specifically, in an embodiment, the pozzolanic ingredient(s) may include, for example, fly ash, metakaolin, blast furnace slag, or silica fume. Further, in an embodiment, the one or more coarse or fine aggregates may include, for example, sand, gravel, stone, and/or recycled concrete aggregates. In addition, in particular embodiments, where the fiber material(s) of the material fragments 202 include glass fibers, the glass fibers are configured to react with the alkali activator to form the usable geopolymer concrete.

As such, the geopolymer concrete described herein may be used in a variety of useful applications. For example, in an embodiment, as shown in FIG. 5 at step (F), the method 100 may also include using the usable geopolymer concrete to form a tower of another wind turbine.

Various aspects and embodiments of the present invention are defined by the following numbered clauses:

Clause 1. A method for recycling a used rotor blade of a wind turbine, the used rotor blade formed of at least one composite material reinforced with at least one fiber material, the method comprising:

processing the used rotor blade into a plurality of material fragments;

treating the plurality of material fragments to remove at least a portion of the at least one composite material and expose the at least one fiber material of the used rotor blade; and,

mixing the treated plurality of material fragments with, at least, an alkali activator to form a usable geopolymer concrete.

Clause 2. The method of clause 1, wherein processing the rotor blade into the plurality of material fragments comprises at least one of manually cutting the rotor blade into the plurality of material fragments or machining the rotor blade into the plurality of material fragments.

Clause 3. The method of any of the preceding clauses, wherein a maximum dimension of each of the plurality of material fragments is equal to or below 80 millimeters (mm).

Clause 4. The method of the preceding clauses, wherein treating the plurality of material fragments to remove at least a portion of the at least one composite material and expose the at least one fiber material of the used rotor blade further comprises at least one of immersing at least a portion of each of the plurality of material fragments into a solvent material and subsequently removing the plurality of material fragments from the solvent material, applying temperature variations to each of the plurality of material fragments, applying mechanical processes to each of the plurality of material fragments, or combinations thereof.

Clause 5. The method of clause 4, wherein the solvent material comprises at least one of sulfuric acid, nitric acid, acetone, isopropanol, xylene, or hydrogen peroxide.

Clause 6. The method of the preceding clauses, further comprising mixing the treated plurality of material fragments with the alkali activator and one or more additional materials to form the usable geopolymer concrete.

Clause 7. The method of clause 6, wherein the one or more additional materials comprise at least one of water, a superplasticizer, one or more pozzolanic materials, one or more coarse or fine aggregates, or combinations thereof.

Clause 8. The method of clause 7, wherein the one or more pozzolanic materials comprise fly ash, blast furnace slag, metakaolin, or silica fume.

Clause 9. The method of clause 7, wherein the one or more coarse or fine aggregates comprise sand, gravel, stone, or recycled concrete aggregates.

Clause 10. The method of the preceding clauses, wherein the at least one fiber material comprises glass fibers, carbon fibers, polymer fibers, wood fibers, bamboo fibers, ceramic fibers, metal fibers, basalt fibers, or similar or combinations thereof.

Clause 11. The method of clause 10, wherein the at least one fiber material comprises the glass fibers, the glass fibers reacting with the alkali activator to form the usable geopolymer concrete.

Clause 12. The method of the preceding clauses, further comprising using the usable geopolymer concrete to form a tower structure.

Clause 13. A geopolymer concrete, comprising:

a slurry comprising:

a plurality of material fragments formed from at least one of a used rotor blade of a wind turbine or rotor blade manufacturing materials;

an alkali activator; and,

water comprising one or more additional materials dissolved therein,

wherein each of the plurality of material fragments has a certain amount of resin removed therefrom to expose at least one fiber material of the used rotor blade or rotor blade manufacturing materials, the exposed at least one fiber material configured to react with the alkali activator.

Clause 14. The geopolymer concrete of clause 13, wherein a maximum dimension of each of the plurality of material fragments is equal to or below 80 millimeters (mm).

Clause 15. The geopolymer concrete of clauses 13-14, wherein the surface coating of each of the plurality of blade segments is removed via a solvent material, the solvent material comprising at least one of sulfuric acid, nitric acid, acetone, isopropanol, xylene, or hydrogen peroxide.

Clause 16. The geopolymer concrete of clauses 13-15, wherein the one or more additional materials comprise at least one of one or more pozzolanic materials, one or more coarse or fine aggregates, a superplasticizer, or combinations thereof.

Clause 17. The geopolymer concrete of clause 16, wherein the one or more pozzolanic materials comprise at least one of fly ash, blast furnace slag, metakaolin, or silica fume, and the one or more coarse or fine aggregates comprise sand, gravel, stone, or recycled concrete aggregates.

Clause 18. The geopolymer concrete of clauses 13-17, wherein the at least one fiber material comprises glass fibers, carbon fibers, polymer fibers, wood fibers, bamboo fibers, ceramic fibers, metal fibers, basalt fibers, or similar or combinations thereof.

Clause 19. The geopolymer concrete of clause 18, wherein the at least one fiber material comprises the glass fibers, the glass fibers reacting with the alkali activator.

Clause 20. A method for recycling a fiber-reinforced composite component, the fiber-reinforced composite component formed of at least one composite material reinforced with at least one fiber material, the method comprising:

processing the fiber-reinforced composite component into a plurality of material fragments;

treating the plurality of material fragments to remove at least a portion of a coating of the fiber-reinforced composite component and expose the at least one fiber material of the fiber-reinforced composite component; and,

mixing the removed plurality of material fragments with, at least, an alkali activator to form a usable geopolymer concrete.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for recycling a used rotor blade of a wind turbine, the used rotor blade formed of at least one composite material reinforced with at least one fiber material, the method comprising:
processing the used rotor blade into a plurality of material fragments;
treating the plurality of material fragments to remove at least a portion of the at least one composite material and expose the at least one fiber material of the used rotor blade; and,
mixing the treated plurality of material fragments with, at least, an alkali activator to form a usable geopolymer concrete.

2. The method of claim 1, wherein processing the rotor blade into the plurality of material fragments comprises at least one of manually cutting the rotor blade into the plurality of material fragments or machining the rotor blade into the plurality of material fragments.

3. The method of claim 1, wherein a maximum dimension of each of the plurality of material fragments is equal to or below 80 millimeters (mm).

4. The method of claim 1, wherein treating the plurality of material fragments to remove at least a portion of the at least one composite material and expose the at least one fiber material of the used rotor blade further comprises at least one of immersing at least a portion of each of the plurality of material fragments into a solvent material and subsequently removing the plurality of material fragments from the solvent material, applying temperature variations to each of the plurality of material fragments, applying mechanical processes to each of the plurality of material fragments, or combinations thereof.

5. The method of claim 4, wherein the solvent material comprises at least one of sulfuric acid, nitric acid, acetone, isopropanol, xylene, or hydrogen peroxide.

6. The method of claim 1, further comprising mixing the treated plurality of material fragments with the alkali activator and one or more additional materials to form the usable geopolymer concrete.

7. The method of claim 6, wherein the one or more additional materials comprise at least one of water, a superplasticizer, one or more pozzolanic materials, one or more coarse or fine aggregates, or combinations thereof.

8. The method of claim 7, wherein the one or more pozzolanic materials comprise fly ash, blast furnace slag, metakaolin, or silica fume.

9. The method of claim 7, wherein the one or more coarse or fine aggregates comprise sand, gravel, stone, or recycled concrete aggregates.

10. The method of claim 1, wherein the at least one fiber material comprises glass fibers, carbon fibers, polymer fibers, wood fibers, bamboo fibers, ceramic fibers, metal fibers, basalt fibers, or similar or combinations thereof.

11. The method of claim 10, wherein the at least one fiber material comprises the glass fibers, the glass fibers reacting with the alkali activator to form the usable geopolymer concrete.

12. The method of claim 1, further comprising using the usable geopolymer concrete to form a tower structure.

13. A geopolymer concrete, comprising:
a slurry comprising:
a plurality of material fragments formed from at least one of a used rotor blade of a wind turbine or rotor blade manufacturing materials;
an alkali activator; and,
water comprising one or more additional materials dissolved therein,
wherein each of the plurality of material fragments has a certain amount of resin removed therefrom to expose at least one fiber material of the used rotor blade or rotor blade manufacturing materials, the exposed at least one fiber material configured to react with the alkali activator.

14. The geopolymer concrete of claim 13, wherein a maximum dimension of each of the plurality of material fragments is equal to or below 80 millimeters (mm).

15. The geopolymer concrete of claim 13, wherein the surface coating of each of the plurality of blade segments is removed via a solvent material, the solvent material comprising at least one of sulfuric acid, nitric acid, acetone, isopropanol, xylene, or hydrogen peroxide.

16. The geopolymer concrete of claim 13, wherein the one or more additional materials comprise at least one of one or more pozzolanic materials, one or more coarse or fine aggregates, a superplasticizer, or combinations thereof.

17. The geopolymer concrete of claim 16, wherein the one or more pozzolanic materials comprise at least one of fly ash, blast furnace slag, metakaolin, or silica fume, and the one or more coarse or fine aggregates comprise sand, gravel, stone, or recycled concrete aggregates.

18. The geopolymer concrete of claim 12, wherein the at least one fiber material comprises glass fibers, carbon fibers, polymer fibers, wood fibers, bamboo fibers, ceramic fibers, metal fibers, basalt fibers, or similar or combinations thereof.

19. The geopolymer concrete of claim 18, wherein the at least one fiber material comprises the glass fibers, the glass fibers reacting with the alkali activator.

20. A method for recycling a fiber-reinforced composite component, the fiber-reinforced composite component formed of at least one composite material reinforced with at least one fiber material, the method comprising:
processing the fiber-reinforced composite component into a plurality of material fragments;
treating the plurality of material fragments to remove at least a portion of a coating of the fiber-reinforced composite component and expose the at least one fiber material of the fiber-reinforced composite component; and,
mixing the removed plurality of material fragments with, at least, an alkali activator to form a usable geopolymer concrete.
